(19) United States
(12) Patent Application Publication
(10) Pub. No.: US 2009/0225111 A1
(43) Pub. Date: Sep. 10, 2009

(54) Droplet deposition apparatus

(75) Inventors: Werner Zapka, Jarfalla (SE); Bosse Nilsson, Huddinge (SE); Mike De Roos, Kungsagen (SE); Juergen Brunahl, Cambridge (GB)

Correspondence Address: James P Zeller;Marshall Gerstein & Borun, 233 S Wacker Drive, Suite 6300, Chicago, IL, 60606-6357, US

(73) Assignee: XAAR TECHNOLOGY LIMITED, Cambridge (GB)

(21) Appl. No.: 10/380,036

(22) PCT Filed: Sep. 26, 2001
(86) PCT No.: PCT/GB01/04307

§ 371 Date: Jan. 28, 2005

(30) Foreign Application Priority Data
Sep. 26, 2000 (GB) 0023545.7

(51) Int. Cl. B41J 29/38

(52) U.S. Cl. 347/10

(57) ABSTRACT

Droplet deposition apparatus comprises a plurality of fluid chambers (2), each fluid ejection chamber being defined in part by at least one wall (11) actuable by an electrical signal to effect droplet ejection from that chamber. The apparatus provides means (16) for cyclically supplying electrical signals to the walls (11) for actuation thereof, means (60) for measuring, within a period between the application of successive electrical signals to the walls, a temperature dependent electrical property of a wall of a fluid chamber to provide a signal having a magnitude dependant on the temperature of fluid in the fluid chambers, and means for adjusting the magnitude of the actuating electrical signals depending on the magnitude of the temperature dependant signal.

The present invention relates to a droplet deposition apparatus such as, for example, a drop-on-demand inkjet printer.

In particular the invention is concerned with a printer or other droplet deposition apparatus in which an acoustic pressure wave is generated by an electrical signal to eject a droplet of fluid (e.g. ink) from a chamber. The apparatus may have a single such droplet ejection chamber, but more typically has a printhead with an array of such chambers each with a respective nozzle, the printhead receiving data-carrying actuating electrical signals which provide the power necessary to eject droplets from the chambers on demand. Each chamber is bounded by a piezoelectric element which is caused to deflect by the actuating electrical signal, thereby generating the acoustic pressure wave which ejects the droplet. Reference is made to our published specifications EP 0277703, U.S. Pat. No. 4,887,100 and WO91/17051 for further details of typical constructions.

These specifications describe arrangements in which piezoelectric material is in a “chevron” configuration, in which a longitudinal side of the chamber is bounded by piezoelectric material having oppositely-poled regions extending longitudinally of the chamber, so that application of the electrical signal deforms both regions of the material in the same direction and into a chevron shape, when viewed in cross-section. Such a configuration is described in the context of an “end-shooter” print-head in EP 0277703, in which the nozzle is at the end of elongated chamber and the piezoelectric material is disposed along the sides of the chamber. Alternatively or in addition, the printhead can be configured as a “side shooter” as described in WO91/17051 in which the nozzle is instead disposed in one of the long sides of the chamber which is not bounded by piezoelectric material. Both of these designs provide significant reductions in the drive voltage for a given droplet ejection performance.

During printing, heat is generated by, for example, the drive circuitry providing the actuating electrical signals to the piezoelectric material. This heat dissipates into the ejection chambers and heats up the ejection fluid therein. This gives rise to a decrease in the viscosity of the ejection fluid. Such variations in the viscosity of the ejection fluid can give rise to variations in droplet ejection velocity and consequent dot placement errors in the printed image. Furthermore, as described in WO97/35167, hysteresis losses resulting from actuation of the piezoelectric material can cause an increase in the temperature of the ink in the ejection channels. In extreme cases, this temperature increase can be local to the active channel and the neighbouring channels only.

We have discovered that it is desirable to monitor the temperature of the droplet ejection fluid during printing and adjust the magnitude of the actuating signals in response to the monitored temperature. One known technique is to mount a thermistor on the external surface of the printhead in the proximity of a piezoelectric element, the thermistor being electrically connected to the drive circuitry. Any temperature increase in the location of the thermistor thus causes a reduction in a resistance value of the drive circuitry, which is used to reduce the magnitude of the actuating electrical signals applied to the piezoelectric element. However, the thermal insulation provided between the thermistor and the piezoelectric element by the casing of the printhead and the glue layer attaching the thermistor to the casing results in a difference between the temperature at the thermistor and the temperature of the droplet ejection fluid. This difference can be substantial if there are fast temperature changes in the printhead during printing, as there is a slow reactance of the drive circuitry to the temperature changes in the ejection fluid.

The preferred embodiment of the present invention seeks to solve these and other problems.

In one aspect, the present invention provides droplet deposition apparatus comprising a plurality of fluid chambers, for each fluid chamber, piezoelectric actuator means actuable by an electrical signal to effect droplet ejection from that chamber, means for cyclically supplying electrical signals to each said actuator means for actuation thereof, means for measuring, within a period between the application of successive electrical signals to a said actuator means, a temperature dependent electrical property of said actuator means to provide a signal having a magnitude dependant on the temperature of fluid in a fluid chamber associated with said actuator means, and means for adjusting the magnitude of the actuating electrical signals, for example, the amplitude and/or duration, depending on the magnitude of the temperature dependant signal.

The inventors of the present application have realised the importance of ensuring that any temperature sensor should be in direct contact with the ejection fluid during printing. The inventors have also realised that any such temperature sensing should not interfere with the standard printing operations or printing speed of the printhead. As the temperature sensing takes place wholly within a period between application of successive electrical signals, this can ensure that the temperature sensing does not interfere with the actuating electrical signals or reduce printing speed.

In one embodiment, the supply means is arranged to supply electrical signals to the actuating means at a frequency in the range from 4 to 5 kHz, preferably 4.2 kHz. The period may have a duration of 240 μs. In one embodiment, the time taken to measure the electrical property takes 42 μs, significantly less than the period of 240 μs between actuation.

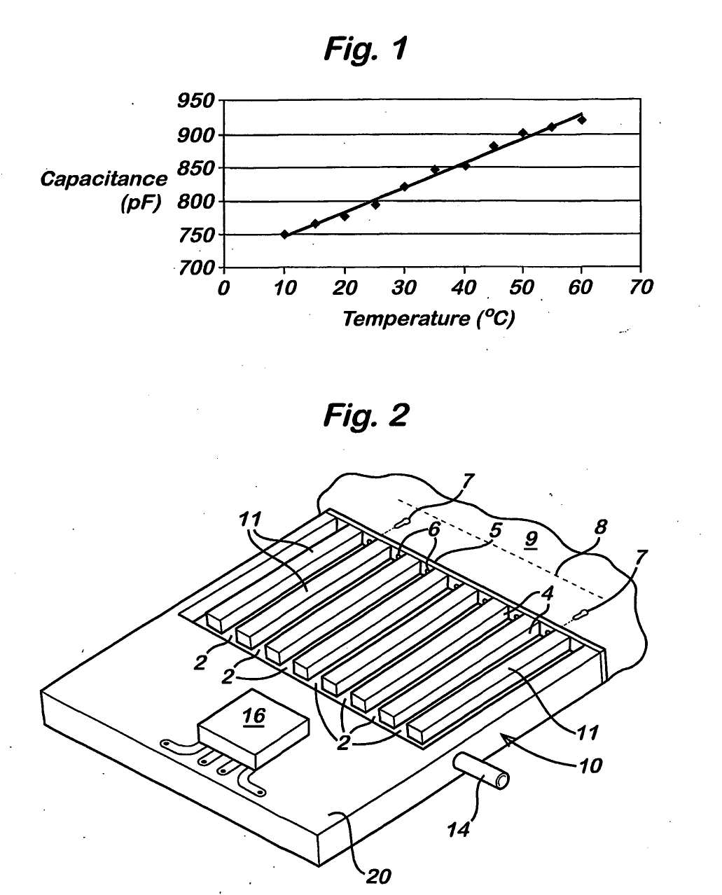

In a preferred embodiment, the temperature dependent electrical property is electrical capacitance. With reference to FIG. 1, the inventors of the present application have found, and verified experimentally, that the capacitance of the piezoelectric actuator of a fluid chamber is a substantially linear function of temperature. As a consequence, the magnitude of the temperature dependent signal can be directly proportional to the temperature of the ink.

Said actuator means preferably comprises piezoelectric material extending over the major part of a wall of a respective said chamber, each actuable channel wall being deformable upon the application of an actuating electrical signal to eject fluid from a fluid chamber. Thus, in a preferred embodiment the present invention provides droplet deposition apparatus comprising a plurality of fluid chambers, each fluid ejection chamber being defined in part by at least one wall actuable by an electrical signal to effect droplet ejection from that chamber, means for cyclically supplying electrical signals to the walls for actuation thereof, means for measuring, within a period between the application of successive electrical signals to the walls, a temperature dependent electrical property of a wall of a fluid chamber to provide a signal having a magnitude dependant on the temperature of fluid in the fluid chambers, and means for adjusting the magnitude of the actuating electrical signals, for example, the amplitude and/or duration of the actuating electrical signals, depending on the magnitude of the temperature dependant signal.

The apparatus preferably comprises means for shaping the temperature dependent signal to provide a temperature dependent voltage signal for superimposition by the adjusting means on the actuating electrical signals. The shaping means may adopt any suitable arrangement according to whether that signal varies linearly or non-linearly with temperature.

In one embodiment the measuring means comprises a measuring circuit comprising two transistors connected in series for receiving a measuring voltage at an input thereof, one side of the wall being connected to a common output of the transistors, the other side of the wall being connected to an output from the circuit, and means connected to the output for measuring the rate of decay of the voltage at the output to provide the signal having a magnitude dependant on the temperature of fluid in the fluid chambers. In order to prevent excessive heating of the wall during measurement, a 5V supply may be connected to the input to provide the measuring voltage.

Preferably, the piezoelectric material is such that application of the actuating electrical signal deforms it in shear mode to generate an acoustic pressure wave in the fluid ejection chamber and thereby eject the fluid.

In a preferred arrangement, the piezoelectric material is disposed along the sides of each fluid chamber. The droplet deposition apparatus can take either an “end-shooter” or “side shooter” configuration. Alternatively, piezoelectric material may be disposed at the back of each fluid chamber, as described in our published specification WO00/16981, so that application of an actuating signal to the piezoelectric material causes it to move towards or away from the nozzle of the ejection chamber, thereby generating the required acoustic pressure wave for fluid ejection.

The present invention also provides droplet deposition apparatus including an array of fluid ejection chambers, each fluid ejection chamber comprising means for ejecting a droplet therefrom in response to an electrical actuating signal, comprising means exposed to fluid in the chambers to provide a signal dependent on the temperature of that fluid, and means responsive to the temperature dependent signal for adjusting the actuating electrical signals. Preferably, each fluid ejection chamber is defined in part by at least one wall actuable by an electrical signal to effect droplet ejection from that chamber, the apparatus comprising means for utilising a temperature dependent electrical property of the wall to provide the signal.

The present invention also provides a method of operating droplet deposition apparatus comprising a plurality of fluid chambers and, for each fluid chamber, piezoelectric actuator means actuable by an electrical signal to effect droplet ejection from that chamber, the method comprising the steps of:

cyclically supplying electrical signals to each said actuator means for actuation thereof;

measuring, within a period between the application of successive electrical signals to a said actuator means, a temperature dependent electrical property of said actuator means to provide a signal having a magnitude dependant on the temperature of fluid in the fluid chamber associated with said actuator means; and

adjusting the magnitude of the actuating electrical signals depending on the magnitude of the temperature dependant signal.

An embodiment of the invention will now be described with reference to the accompanying drawings, in which:—

FIG. 1 shows the variation of capacitance with temperature for an actuable wall of a fluid chamber;

FIG. 2 is a perspective view of an end-shooter chevron printhead;

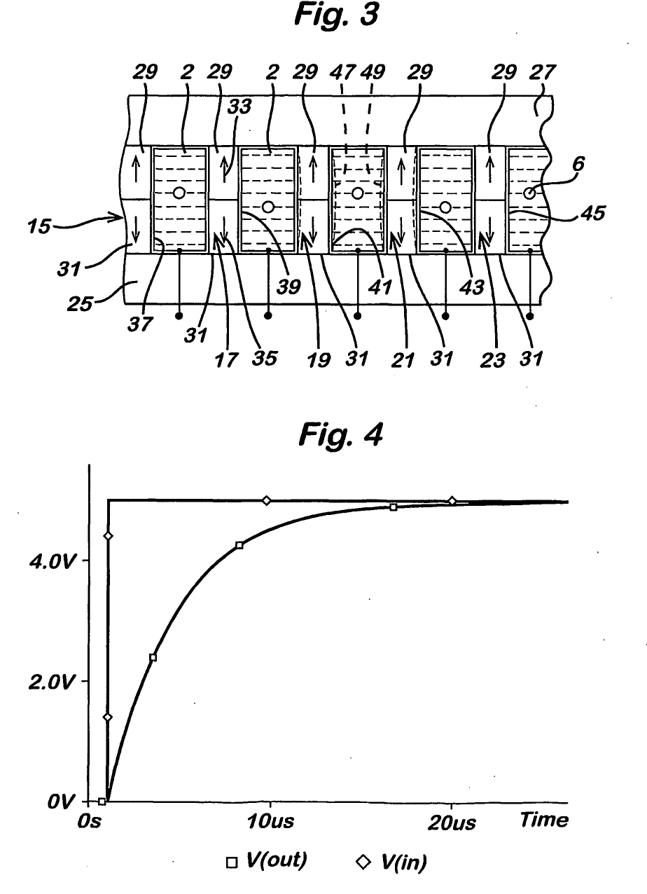

FIG. 3 is a section through the printhead of FIG. 2;

FIG. 4 illustrates the charging curve of a capacitor;

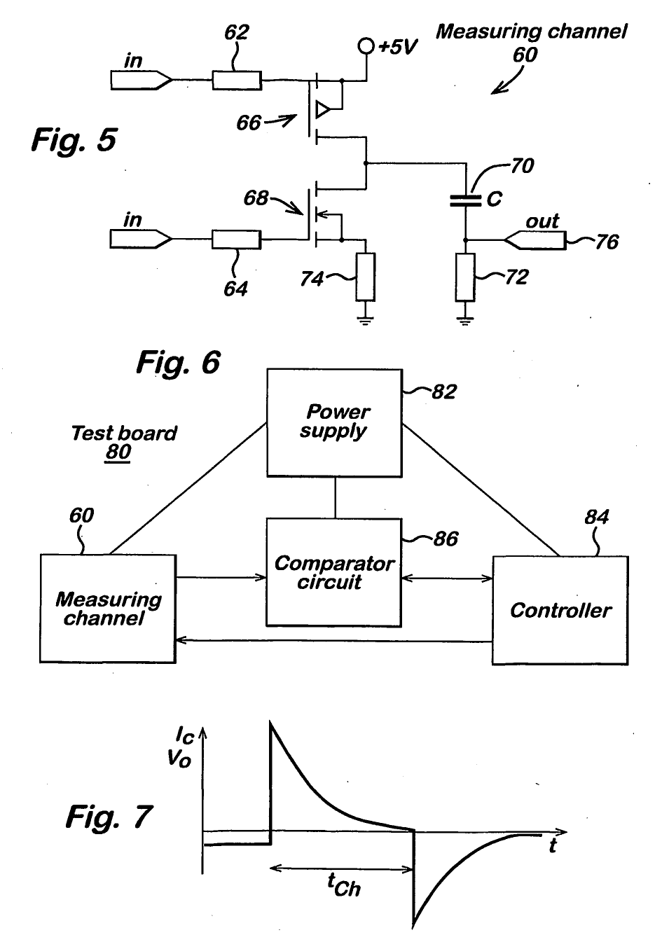

FIG. 5 illustrates the arrangement of a measuring circuit used to provide a signal indicative of the temperature of fluid in the printhead;

FIG. 6 illustrates in block diagram form a test board including the measuring circuit; and

FIG. 7 illustrates the output of the measuring circuit.

Referring first to FIG. 2, a planar array, drop-on demand ink jet printer according to an embodiment of the present invention comprises a printhead 10 formed with a multiplicity of parallel fluid chambers or channels 2, nine only of which are shown and the longitudinal axes of which are disposed in a plane. The channels 2 are closed by a cover (not shown) which extends over the entire top surface of the printhead.

The channels are of end-shooter configuration, terminating at corresponding ends thereof in a nozzle plate 5 in which are formed nozzles 6, one for each fluid ejection channel 2. Fluid, such as ink 4, is ejected on demand from the fluid ejection channels 2 in the form of droplets 7 and deposited on a print line 8 of a print surface 9 between which and the printhead 10 there is relative motion normal to the plane of the channel axes.

The printhead 10 has a planar base part 20 in which the channels 2 are cut or otherwise formed of a PZT piezoelectric material so as to extend in parallel rearwardly from the nozzle plate 5. The channels 2 are long and narrow with a rectangular cross-section and have opposite side walls 11 which extend the length of the channels. The side walls 11 of the fluid ejection channels 2 are provided with electrodes (not shown) extending along the length of the channels whereby the side walls are displaceable in shear mode transversely relatively to the channel axes along substantially the whole of the length thereof, to cause changes of pressure in the ink in the channels 2 to effect droplet ejection from the nozzle.

The channels 2 connect at their ends remote from the nozzles, with a transverse channel (not shown) which in turn connects with an ink reservoir (not shown) by way of pipe 14. Electrical connections (not shown) for activating the side walls 11 of the fluid ejection channels are made to an LSI chip 16 on the base part 20. Typically, a chip 16 is connected to up to 32 separate electrodes for supplying electrical signals thereto for displacement of the associated side walls of the fluid ejection channels 2, and therefore it is usual for a plurality of chips 16 to be provided for supply of actuating electrical signals to the side walls of all of the channels in the array. However, the number of electrodes to which a chip is connected can, of course, be modified as required.

As shown in FIG. 3, the channel side walls 11 have oppositely-poled regions so that application of an electric field deflects them into a chevron shape. The array incorporates displaceable side walls 11 in the form of shear mode actuators 15, 17, 19, 21 and 23 sandwiched between base and top walls 25 and 27 and each formed of upper and lower wall parts 29 and 31 which, as indicated by arrows 33 and 35, are poled in opposite senses normal to the plane containing the channel axes.

The inner walls of the fluid ejection channels 2 are covered by respective electrodes 37, 39, 41, 43 and 45. Thus, when a voltage is applied to the electrode of a particular channel, say electrode 41 of the channel 2 between shear mode actuator 19 and 21, whilst the electrodes 39 and 43 of the channels 2 on either side of that of electrode 41 are held to ground, an electric field is applied in opposite senses to the actuators 19 and 21. By virtue of the opposite poling of the upper and lower wall parts 29 and 31 of each actuator, these are deflected in shear mode into the channel 2 therebetween in chevron form as indicated by broken lines 47 and 49. An impulse
is thus applied to the ink 4 in the channel 2 between the actuators 19 and 21 which causes an acoustic pressure wave to travel along the length of the channel and eject an ink droplet 7 therefrom.

During printing, heat is generated by, for example, the chip 16. This heat dissipates into the fluid chambers 2 and increases the temperature of the ink 4, which gives rise to a decrease in the viscosity of the ink 4. Such variations in the viscosity of the ink can result in variations in droplet ejection velocity and consequent dot placement errors in the printed image. To seek to avoid such errors, in the present droplet deposition apparatus the temperature of the ink is monitored during printing. This enables the magnitude of the actuating signals applied to the walls 11 of the fluid ejection chambers 2 to be adjusted in response to the monitored temperature so as to compensate for the decrease in the viscosity of the ink.

In the present apparatus a temperature dependent electrical property of an actuable side wall 11 is used to monitor the temperature of ink 4 during printing. As the walls 11 are in direct contact with the ink 4, any rapid changes in the temperature of the ink 4 can be detected and acted upon quickly.

With reference to FIG. 1, the inventors of the present application have found, and verified experimentally, that the capacitance of the walls 11 of a channel 2 is a substantially linear function of temperature. As a consequence, the magnitude of the temperature dependent signal can be directly proportional to the temperature of the ink. FIG. 4 shows a standard charging curve for a capacitor.

With reference to FIG. 5, a measuring circuit 60 is used to provide a signal having a magnitude dependant on the temperature of ink in the channels 2.

The circuit 60 comprises two input resistors 62,64 each connected to the gate of a respective one of a pair of transistors 66,68 connected in series. The wall of a channel 2 is represented at 70 as a capacitance C to be measured, the capacitor 70 being connected at one side thereof to the commonly-connected drains of transistors 66,68 and at the other side thereof to a first output resistor 72. A second output resistor 74 is connected to the source of transistor 68. A 5 volt input is supplied to the source of transistor 66, and an output 76 is connected to the other side of the capacitor 70. The measuring circuit is sufficiently simple to be implementable in an ASIC mounted on the printhead, for example, as part of the chip 16.

FIG. 6 illustrates a test board 80 carrying the measuring circuit 60, a power supply 82, a controller 84 and a comparator circuit 86.

The output of the measuring circuit 60 is supplied to the comparator circuit 86. The output at contact 76 is illustrated in FIG. 7 which shows a curve representing either the charging current Ic of the capacitor 70, or the voltage Vo at contact 76, as a function of time t.

It will be seen that the current or voltage increases sharply then decays to zero before going negative. The capacitance of the capacitor 70 is proportional to the decay or charging time, t(ch). The comparator circuit 86 is arranged to measure this time. The controller 84 can be used to set the comparator 86 to measure the decay to a predetermined percentage, such as 96%.

It has been found by the applicant that the charging/decay time is shorter than the time between activations of a channel 2, so that the measurement of capacitance of the wall of an active channel 2 can be made. There is thus no interference with a printing operation.

For example, for a 200 dots per inch printhead operating at a frequency of 4.2 kHz, a measurement of wall capacitance can be made in 42 microseconds, which is well within the period of 240 microseconds between activations of a channel. Faster measurement is also possible for faster printheads.

Any variation of the wall capacitance, due to deviation of the temperature of the ink 4 from room temperature, varies the decay or charging time, t(ch), in response to which the comparator circuit 86 outputs a signal indicating the temperature of the ink in the channels 2. The signal is subsequently shaped to enable the signal to be superimposed on the actuating electrical signals supplied to the wall. This in turn modifies the velocity of the droplets ejected from the ejection channel 2 so as to avoid drop placement errors.

As mentioned above, in the preferred embodiment a single chip 16 supplies actuating electrical signals to up to 32 electrodes only, and thus controls the ejection of droplets from a group of up to 32 channels. Therefore, a plurality of chips 16 are typically provided, each controlling the ejection from a respective channel group. In one embodiment, the capacitance of one of the walls of each of the groups is measured regularly by a respective chip 16, and the magnitude of the actuating channels supplied to the walls of the channels in that group is adjusted accordingly. Thus, by measuring the capacitance of each 32^{nd} wall of the array, the magnitude of the actuating electrical signals can be varied across the array in dependence on the actuation sequence. To increase temperature sensitivity across the array, the number of walls in each group may be reduced.

An advantage of the invention is that, using active channels, temperature homogeneity across a multichannel printhead can be measured. A further advantage is that the measuring circuit is sufficiently simple to be implementable in an ASIC mounted on the printhead, e.g. as part of the chip 16. Also, the use of a 5 volt supply means that there is no additional heating of the printhead even when measurements are made every second.

It will be understood that the present invention has been described above purely by way of example, and modifications of detail can be made within the scope of the invention.

For example, although the present invention as been described with reference to an “end-shooter” printhead, it is equally applicable to a “side shooter” or any other form of printhead.

Furthermore, any suitable means may be employed for detecting the capacitance, or other suitable electrical property, of the walls of the actuable channels. For example, a digital detection circuit may be employed in order to avoid problems associated with the generation of noise during detection of the chosen electrical property

Each feature disclosed in this specification (which term includes the claims) and/or shown in the drawings may be incorporated in the invention independently of other disclosed and/or illustrated features.

1. Droplet deposition apparatus comprising:
a plurality of fluid chambers;
for each fluid chamber; piezoelectric actuator means actuable by an electrical signal to effect droplet ejection from that chamber;
means for cyclically supplying electrical signals to each said actuator means for actuation thereof;
means for measuring, within a period between the application of successive electrical signals to a said actuator means, a temperature dependent electrical property of said actuator means to provide a signal having a magnitude dependant on the temperature of fluid in a fluid chamber associated with said actuator means; and
means for adjusting the magnitude of the actuating electrical signals depending on the magnitude of the temperature dependant signal.

2. Droplet deposition apparatus according to claim 1, wherein the supply means is arranged to supply electrical signals to the actuator means at a frequency in the range from 4 to 5 kHz.

3. Droplet deposition apparatus according to claim 2, wherein the supply means is arranged to supply electrical signals at a frequency of 4.2 kHz.

4. Droplet deposition apparatus according to any preceding claim, wherein the period has a duration of 240 μs.

5. Droplet deposition apparatus according to any preceding claim wherein the temperature dependent electrical property is electrical capacitance.

6. Droplet deposition apparatus according to any preceding claim, wherein said actuator means comprise piezoelectric material extending over the major part of a wall of a respective said chamber, each actuable channel wall being deformable upon the application of an actuating electrical signal to eject fluid from a fluid chamber.

7. Droplet deposition apparatus according to claim 6, wherein the measuring means comprises a measuring circuit comprising two transistors connected in series for receiving a measuring voltage at an input thereof, one side of the wall being connected to a common output of the transistors, the other side of the wall being connected to an output from the circuit, and means connected to the output for measuring the rate of decay of the voltage at the output to provide the signal having a magnitude dependant on the temperature of fluid in the fluid chamber.

8. Droplet deposition apparatus according to claim 7, wherein a 5V supply is connected to the input to provide the measuring voltage.

9. Droplet deposition apparatus according to any of claims 6 to 8, wherein the piezoelectric material is such that application of the actuating electrical signal deforms it in shear mode to generate an acoustic pressure wave in the fluid chamber and thereby eject the fluid.

10. Droplet deposition apparatus according to any of claims 6 to 9, wherein the piezoelectric material is disposed along the sides of each fluid chamber.

11. A method of operating droplet deposition apparatus comprising a plurality of fluid chambers and, for each fluid chamber, piezoelectric actuator means actuable by an electrical signal to effect droplet ejection from that chamber, the method comprising the steps of:
cyclically supplying electrical signals to each said actuator means for actuation thereof;
measuring, within a period between the application of successive electrical signals to a said actuator means, a temperature dependent electrical property of said actuator means to provide a signal having a magnitude dependant on the temperature of fluid in the fluid chamber associated with said actuator means; and
adjusting the magnitude of the actuating electrical signals depending on the magnitude of the temperature dependant signal.

12. Droplet deposition apparatus substantially as herein described with reference to the accompanying drawings.

13. A method of operating droplet deposition apparatus substantially as herein described with reference to the accompanying drawings.
